(19) United States
(12) Patent Application Publication
(10) Pub. No.: US 2016/0379814 A1
(43) Pub. Date: Dec. 29, 2016

(54) MOLECULAR DETECTION APPARATUS AND METHOD

(71) Applicant: Kabushiki Kaisha Toshiba, Minato-ku (JP)

(72) Inventors: Ko YAMADA, Yokohama (JP); Yasuko Noritomi, Kawasaki (JP)

(73) Assignee: Kabushiki Kaisha Toshiba, Minato-ku (JP)

(21) Appl. No.: 15/257,265

(22) Filed: Sep. 6, 2016

Related U.S. Application Data
(63) Continuation of application No. PCT/JP2014/056937, filed on Mar. 14, 2014.

(51) Int. Cl. H01J 49/14; H01J 49/26; G01N 21/65

(52) U.S. Cl. CPC H01J 49/145; G01N 21/658; H01J 49/26

(57) ABSTRACT

According to one embodiment, a molecular detection apparatus includes an ionizer, a voltage applier, a separator and a detector. The ionizer attaches ions to a substance group including substances that differ in molecular weight to obtain an ionized substance group. The voltage applier applies a voltage to the ionized substance group to cause the ionized substance group to fly toward a detection surface within measurement space. The separator applies a voltage to a flying ionized substance group to bend a flight trajectory, removes a substance whose molecular weight is not more than a threshold from the flying ionized substance group, and extracts a substance whose molecular weight is more than the threshold as a measuring object. The detector performs a photo detection process to obtain a spectrum of the measuring object.

### CROSS-REFERENCE TO RELATED APPLICATIONS

This application is a Continuation application of PCT Application No. PCT/JP2014/056937, filed Mar. 14, 2014, the entire contents of which are incorporated herein by reference.

### FIELD

Embodiments described herein relate generally to a molecular detection apparatus and method.

### BACKGROUND

It is feared that an epidemic (pandemic) will be expanded by infectious agents drifting among people through the air. To identify an infectious pathogen that is to be a source of infection, such as an influenza virus, a PCR (Polymerase Chain Reaction) technique for performing a determination using a gene amplification process is generally used. The PCR technique is a technique of taking a sample from mucous membranes of the throat and nose of a patient and checking accurate information from the genetic level using the sample, and its accuracy is higher than that in amplification using animals and cultured cells.

In the PCR technique, however, due to the nature of the fact that a process is performed using a liquid phase and an amplification process is performed, at least several days are required for identifying an infectious pathogen. Furthermore, a number of constraints are imposed and, for example, the processes need to be performed in a laboratory that ensures a biosecurity level. If a time required for identifying an infectious pathogen whose infection is expanded is shorter, the expansion of an epidemic can be minimized. It is thus desirable to identify an infectious pathogen by a simple method in a short time.

As a technique for collecting or analyzing materials, there is a technique for capturing materials or viruses from a gaseous layer.

### BRIEF DESCRIPTION OF THE DRAWINGS

FIG. 1 is a block diagram showing a molecular detection apparatus according to a first embodiment.

FIG. 2 is a diagram showing an example of a dissolution process in a dissolver.

FIG. 3 is a diagram showing an example of arrangement of an ionizer, a voltage applier and a time-of-flight separator according to the first embodiment.

FIG. 4 is a diagram showing details of a detector according to the first embodiment.

FIG. 5A is a diagram showing a first formation example of hot spots in the detector.

FIG. 5B is a diagram showing a second formation example of hot spots in the detector.

FIG. 5C is a diagram showing a third formation example of hot spots in the detector.

FIG. 5D is a diagram showing a fourth formation example of hot spots in the detector.

FIG. 6 is a diagram showing an example of glycoside derivatives.

FIG. 7 is a diagram showing details of a photo-detection process in the detector.

FIG. 8 is a block diagram showing a molecular detection apparatus according to a second embodiment.

FIG. 9 is a diagram showing an example of arrangement of an ionizer, a voltage applier and a time-of-flight separator according to the second embodiment.

FIG. 10 is a diagram showing a photo-detection process and an electron detection process in a detector according to the second embodiment.

FIG. 11 is a block diagram showing a molecular detection system including a molecular detection apparatus according to a third embodiment.

FIG. 12 is a diagram showing an example of usage of data relating to a measuring object.

FIG. 13 is a diagram showing an example of results of signals detected by an electron multiplying method when a measuring object is attached to a detector.

FIG. 14 is a diagram showing an SERS spectrum of a measuring object according to a first example.

FIG. 15 is a diagram showing an SERS spectrum of a measuring object according to a second example.

FIG. 16 is a diagram showing a signal generated by performing an electron detection process for a measuring object according to a third example.

FIG. 17 is a diagram showing an SERS spectrum of a measuring object according to the third embodiment.

### DETAILED DESCRIPTION

In the above-described measurement technique, there is no technique of separating materials, or it is necessary to identify a material manually by concentrating an infectious pathogen as much as possible to increase the concentration thereof and thus an infectious pathogen cannot be identified easily in a short time.

In general, according to one embodiment, a molecular detection apparatus includes an ionizer, a voltage applier, a separator and a detector. The ionizer attaches ions to a substance group including substances that differ in molecular weight to obtain an ionized substance group. The voltage applier applies a first voltage to the ionized substance group to cause the ionized substance group to fly toward a detection surface within measurement space. The separator applies a second voltage to a flying ionized substance group to bend a flight trajectory of the flying ionized substance group, removes a substance whose molecular weight is not more than a threshold value from the flying ionized substance group, and extracts a substance whose molecular weight is more than the threshold value as a measuring object. The detector performs a photo detection process to obtain a spectrum of the measuring object attached to the detection surface.

In public places, various invisible substances are floating around in the air. Contaminants such as particulate matter and nitrogen oxides are monitored on a daily basis by the administration. Such sensing devices as to measure concentrations of high-traffic roads on and outdoor spaces, make sufficient measurements in today's world where emission control progresses. On the other hand, in train stations and at the entrances of buildings and department stores, light-weight substances are constantly wound up in the air by ventilation from air conditioners and a flow of people. The light substances include a number of toxic substances and a number of substances such as infectious viruses. Although widespread air purifiers collect many substances, they are used to collect substances limited in a closed space, and not to collect a specific substance. In the space of such highly public facilities where a number of people are coming and going, substances brought from different locations are drifted. Of these substances, infectious substances are of the greatest interest. Every year, a new type of infectious agent is found to pose a threat to people.

In tuberculosis pathogen problems in developing countries, there is a need for rapid determination in the field. Accordingly, devices capable of accurate determination have been developed, and a development trend of rapid devices can be seen in medical-device makers in Japan, too. Thus, rapid identification of pathogen substances is regarded as a global challenge. On the other hand, in East Asia and Western countries, influenza is prevalent from winter to spring. For diagnosis of influenza, a determination kit is used in the field of medical institutions to make it possible to determine whether influenza is type A or type B in about 10 minutes. Since, however, the diagnosis is conducted after a patient visits a hospital after he or she is aware of fever, the patient causes more patients as a source of infection. The current situation cannot be said to be sufficient to break such a vicious circle.

One reason for not breaking a vicious circle is that a remedy starts from a stage where an infected person has been aware of a symptom and a test is conducted first at a point in time apart from prevention. Vaccine is generally used for prevention; however, a required amount of vaccine has to be stocked in advance and the amount of stock is enormous; thus, considerable financial pressure is applied. Since, furthermore, no economic benefits are sufficiently provided to manufacturers that participate in manufacturing, it is very difficult to secure manufacturers in the current situation. In addition, it is desirable to avoid using vaccines for the human body as much as possible because the vaccines have certain side effects and side reactions. From this point of view, an information acquisition device is required to proceed with prevention activities of infectious diseases advantageously.

Furthermore, as a new problem in recent years, while the convenience of cities improves, for example, a public health problem that pathogens brought in from abroad spread quickly is no longer overlooked. A pathogen such as influenza expands every year, and a new type of influenza occurs. Since there is concern that a social panic will be caused, it is important to widen a sense of security to people by suppressing a pathogen from the “viewpoint of prevention.” In the current workaround, when a patient visits a hospital with fever, a pathogen is taken and cultured to carry out a specific operation using inspection devices. This requires a specific period of several days and special facilities that are able to handle the pathogen, and information feedback to the field of medical institutions is slow. In addition to, since an infection spread area is considered equivalent to an area where the number of patients is large, an area where many patients are really infected cannot be identified. Though, in elementary schools, a class has only to be closed in accordance with the number of patients, public transportation in which a variety of people such as businessmen, overseas travelers, mothers who are pushing their strollers, and the elderly come and go cannot easily be closed or isolated; thus, it is hard to say that the spread of infection is effectively contained. As a result, a method of predicting the number of patients that are generated in advance and stockpiling vaccines prophylactically has been taken, and the administration has devoted a budget of even several tens of billion yen per year. These vaccines are not used but discarded if a different type of influenza is spread. If, therefore, a method of obtaining appropriate infection spread information and specifying an infection spread place in a narrow range based upon the “viewpoint of prevention” to perform suppression activities is established, the number of infected patients can be decreased and the amount of stockpile vaccine can be reduced, with the result that even in today's society that becomes compact cities increasingly, health maintenance of everybody can be performed steadily. Especially elementary school and younger children become victims of many infectious diseases and, in Japan that is aging, it is said that to prevent infectious diseases from expanding effectively is a pressing issue for development of the next generation.

The device required in the foregoing environment is a device that is installed in a public place to identify, e.g. a pathogen substance by collecting gas from the air and separating substances. As one similar to such a device is an air purifier. This device performs nothing but removes components using a filter or neutralizes a pathogen substance by negative ions or the like, and does not identify a pathogen substance that became the source of infection. Furthermore, as a technique for identifying a substance, there is a mass spectrometer, but it has no structure to receive gaseous components directly, though a process of laser sublimation after fabrication of a solid sample is essential to measure a substance such as protein. Since the length of the device is a few meters and greater than the height of a person and the price of the device is several tens of million yen, it is very difficult to install the device in a public place as an ordinary device.

Furthermore, a large amount of livestock, such as chickens and pigs that produce zoonotic infections, are sometimes disposed of if it is found that they have been infected with a specific pathogen. This is currently performed as unavoidable measures in order to prevent the infection to human beings. For example, if bird flu that will lead to the generation of new influenza occurs in a poultry house, an event such as that livestock around the poultry house will be disposed of prophylactically is caused. In addition to a big economic loss and an ethical problem, for example, producers' longtime efforts are lost, and the influence becomes widespread. It is desired that such measures be avoided as much as possible.

Hereinafter, a molecular detection apparatus and method according to the present embodiments will be described in detail with reference to the drawings. In the following embodiments, the explanation of the elements with the same reference numerals will be omitted for brevity as their operations will be the same.

### First Embodiment

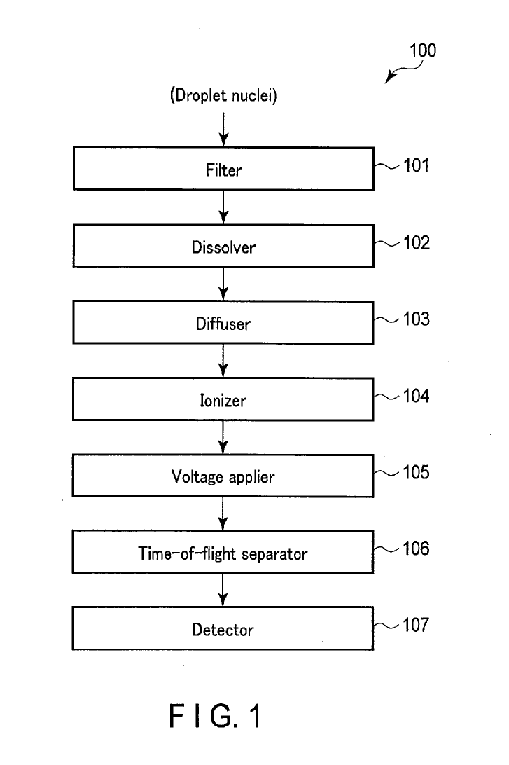

A molecular detection apparatus according to a first embodiment will be described with reference to the block diagram of FIG. 1.

A molecular detection apparatus 100 according to the first embodiment includes a filter 101, a dissolver 102, a diffuser 103, an ionizer 104, a voltage applier 105, a time-of-flight separator 106 and a detector 107.

The filter 101 uses a general moderate-high-performance filter to introduce air containing droplet nuclei floating in the air as intake air and remove particles such as floating dust. The droplet nuclei include, for example, various water-soluble proteins formed from a saliva ingredient released by sneezing and coughing of people. Since the droplet nuclei include a high-viscosity substance consisting chiefly of mucin, they involve pathogen particles such as viruses and bacteria. Here, a substance that could be a source of infection, such as influenza viruses and bacteria will be described as an example of a measuring object, which is a target substance to be detected. In other words, the droplet nuclei include a measuring object.

The above droplet nuclei becomes a mass from which moisture is lost to some extent in the air. The droplet nuclei from which moisture is lost are very light-weight and their drop velocity is low. Thus, the droplet nuclei rise up due to, e.g. the movement of people and continue to drift in the air in train stations and underground passages. Therefore, a measuring object has only to be taken in along with the outside air and large particles of several microns or greater have only to be removed through a filter. For example, most of the dried particles, such as droplet nuclei are about 5 μm; thus, dust of about 20 μm or greater has only to be removed effectively through a moderate-high-performance filter.

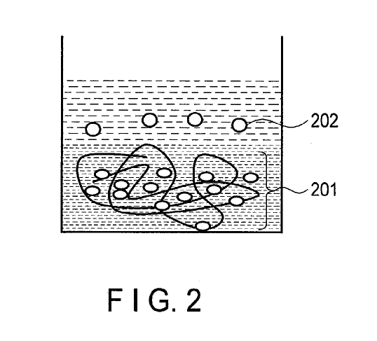

The dissolver 102 dissolves intake air containing the droplet nuclei that has passed through the filter 101 to a solution. The dissolver 102 will be described in detail later with reference to FIG. 2.

The diffuser 103 diffuses substances that differ in molecular weight, which are contained in the droplet nuclei dissolved by the dissolution section 102, or measuring objects, such as interior substances and pathogens. As a method for the diffusion, for example, the droplet nuclei has only to be splashed by applying strong air to the fluid level of the solution in which the droplet nuclei is dissolved. Alternatively, they can be diffused using a micro spray method or, they can be sprayed through a nozzle. Incidentally, the diffused substances are also referred to as a substance group.

The ionizer 104 performs ion attachment to attach ions to the substance group diffused by the diffuser 103. For convenience, a substance to which ions are attached is also referred to as an ionized substance and a substance group to which ions are attached is referred to as an ionized substance group.

The voltage applier 105 receives an ionized substance group from the ionizer 104 and applies a voltage to the ionized substance group. When the a voltage is applied to the ionized substance group, the ionized substance group receives electric-field energy and flies toward the detection surface of the detector 107, which will be described later, in measurement space (for example, in a flight tube).

The time-of-flight separator 106 separates the ionized substance group flying in the measurement space (also referred to as a flying ionized substance group) according to flight time. Since the flight time of the ionized substance depends upon the mass of a substance, the speed of an ionized substance whose mass is small becomes high. Therefore, the mass of a substance can be selected according to the time-of-flight.

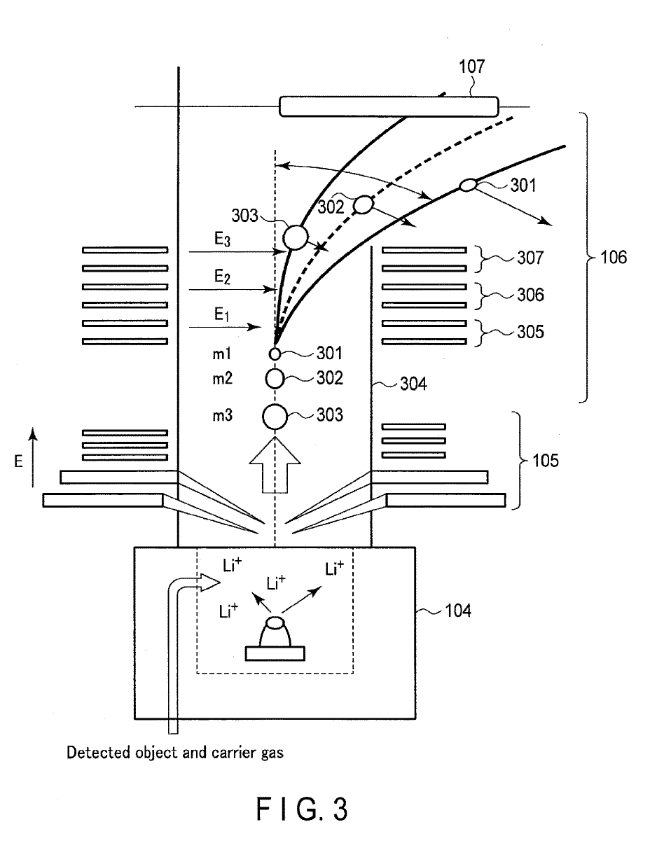

Furthermore, the time-of-flight separator 106 applies a voltage to a flying ionized substance group to bend a flight trajectory of the ionized substance group from the voltage applier 105 to the detection surface of the detector 107. The time-of-flight separator 106 removes an ionized substance having molecular weight, which is equal to or smaller than a threshold value, from the ionized substance group, and extracts an ionized substance having molecular weight, which is greater than the threshold value, as the measuring object. The time-of-flight separator 106 will be described in detail later with reference to FIG. 3.

The detector 107 performs a photo-detection process for the measuring object which flies in the measurement space and attached to the detection surface to obtain a spectrum of the measuring object. As the photo-detection process, for example, the Raman scattering spectroscopy or surface-enhanced Raman scattering (SERS) spectroscopy has only to be detected using a spectrometer to perform a process of obtaining a scattering spectrum for the measuring object.

Next, an example of a dissolution process in the dissolver 102 will be described with reference to FIG. 2.

As the dissolution process of the dissolver 102, droplet nuclei are dissolved in a solution as shown in FIG. 2. Molecules 201 having viscosity and very high molecular weight, such as mucin, easily form a precipitation lower layer by a centrifugal force. On the other hand, molecules 202, which are pathogens such as a virus, are likely to remain as very small particles in a supernatant solution. Therefore, droplet nuclei containing micro particles, such as pathogens particles, include a virus that is a measuring object in a supernatant solution, and insoluble substances can be removed along with the dissolution.

When a dissolution process is performed, droplet nuclei can be vibrated by ultrasonic waves. The vibration allows the droplet nuclei to be dissolved with efficiency. Furthermore, they can be separated by a centrifugal force, and, for example, the rotational speed has only to be approximately 3000 rpm and time has only to be set to 10 minutes to 20 minutes. Moreover, if the separation needs to be performed in a short time, the rotational speed has only to be set at a higher one.

Furthermore, a substance whose specific gravity is high, such as sugar, can be added to a solution and the solution can be centrifuged under mild conditions to selectively remove a sugar component whose specific gravity is high and a precipitate deposited on the boundary of the solution. Here, it has only to be necessary to remove and diffuse even a slight amount of objects to be detected and most of the sugar components and the protein components whose molecular weight is very high can be eliminated. As a guide, about 10⁴ (number/mL) diffusion has only to be obtained.

As a high molecular weight, molecules whose molecular weight is higher than 3000 are assumed. Generally, the molecular weight of 3000 is recognized as a boundary that separates sugars called oligosaccharides of low molecular weight and sugars called polysaccharides of high molecular weight. In the present embodiment, a substance whose molecular weight is 3000 or lower does not correspond to an intended measuring object.

An example of arrangement of the ionizer 104, voltage applier 105 and time-of-flight separator 106 will be described below with reference to the conceptual diagram of FIG. 3.

FIG. 3 shows a relationship in arrangement among the ionizer 104, voltage applier 105 and time-of-flight separator 106. The ionizer 104 receives a measuring object and a carrier gas diffused by the diffuser 103 and attaches ions to substances. For example, the ionizer heats an oxide containing lithium or sodium to around 250° C. in a vacuum of about 100 Pa to generate ions, and attaches the generated ions to substances to ionize the substances, thereby generating an ionized substance group including a plurality of ionized substances. The oxide is composed of a lithium oxide, an aluminum oxide and a silicon oxide, and it is desirable that the mole ratio of these oxides be 1:1:1 in order to emit lithium ions efficiently. This mole ration allows the substances to be ionized nondestructively. The lithium ions can be replaced with sodium ions.

The ionizer 104 according to the present embodiment is able to ionize a measuring object stably because there is no possibility that a radical will be generated as in a method of generating ions with a laser beam.

The ionized substance group passes through a source ion lens to arrange their ionic radii. The source ion lens can also be configured to serve as the voltage applier 105. The voltage applier 105 applies a voltage of about several kilovolts to accelerate the ionized substance group and lead the ionized substance group into a flight tube in a high vacuum. The ionized substance group flies in the flight tube.

Here, if the measuring object is a pathogen such as a virus that consists of a number of proteins, the mass of the measuring object is very large. On the other hand, the mass of water, odorous substances, steam of solvent or the like is relatively small. Therefore, the ionized substances can be separated using a difference in mass between these objects. In other words, since ion attachment is not effectively performed for impurities such as water and nitrogen of low molecular weight, the impurities cannot fly in the measurement space and will be removed under a reduced pressure.

In the flight tube, there is a characteristic that the flight speed of a substance the mass of which is small is high and that of a substance the mass of which is large is low in proportion to kinetic energy. This characteristic can be expressed by the equation (1):

t∝\sqrt{m} (1)

where t is flight time and m is mass. In the example of FIG. 3, the mass of an ionized substance 301 is m1, that of an ionized substance 302 is m2 and that of an ionized substance 303 is m3, and these substances are flying in a flight tube 304. Assuming here that the relationship in mass is given as m3>m2>m1, of the three ionized substances, the ionized substance 301 having the smallest mass m1 flies at the highest flight speed and the ionized substance 303 having the largest mass m3 flies at the shortest flight speed.

The time-of-flight separator 106 detects an ionized substance the mass of which is large, such as a virus, and applies a voltage to bend the flight trajectory of the ionized substance to prevent an ionized substance the mass of which is small from reaching the detector 107 in the subsequent stage. If a voltage is applied, the flight trajectory of an ionized substance the mass of which is small is easily bent, but an ionized substance the mass of which is large has high kinetic energy and thus is not easily bent but continues flying with a linear path.

If, therefore, the value of a voltage applied in the time-of-flight separator 106 is adjusted as appropriate, an undesired ionized substance can be removed while a desired ionized substance (measuring object) reaching the detector 107, and the measuring object and the undesired substance can be separated. Since, moreover, the ionized substance is separated by bending its flight trajectory, the flight tube 304 can be made shorter than by a method of separation in the flight tube 304 based only on a difference in mass between the ionized substances.

As for the direction of an electric field generated by a voltage, the flight trajectory has only to be bent such that a first measuring object does not reach the detector 107. In the example of FIG. 3, a voltage is applied such that electric fields E1, E2 and E3 are generated perpendicularly to a reference line (broken line) of the flight trajectory of an ionized substance.

The voltage applied at the time-of-flight separator 106 has only to be set to satisfy the equations (2) and (3):

$$\begin{matrix}\frac{1}{2} {mv}^{2} = eV & ( 2 ) \\ \frac{{mv}^{2}}{r} = \frac{eE}{h} & ( 3 )\end{matrix}$$

where V is an acceleration voltage, E is an electrode voltage for bending the flight trajectory, m is the mass of the ionized substance, v is the speed of the ionized substance, r is the radius of the flight trajectory, h is a distance from the reference line of an electrode, which corresponds to half the distance between the electrodes, and e is elementary charge.

FIG. 3 shows an example of separating a voltage into three segments and applying voltages of these segments. Assume that the segment nearest to the voltage applier 105 is segment 305 and then segment 306 and segment 307 are arranged in order toward the detector 107. As one example, the voltage of the segment 306 and segment 307 has only to be set lower than the voltage of the segment 305.

Moreover, the voltages of the segments are not limited as described above, but the setting can be made in consideration of a voltage (acceleration voltage) applied by the voltage applier 105. It is desirable that the initial displacement angle be increased by relatively increasing the voltage of the segment 305 applied first by the time-of-flight separator 106 for the ionized substance group flying by the acceleration voltage. In the present embodiment, an example of separating a voltage into three segments and applying the voltages in these segments is shown, but the embodiment is not limited to this, but a spherical electric field can be applied.

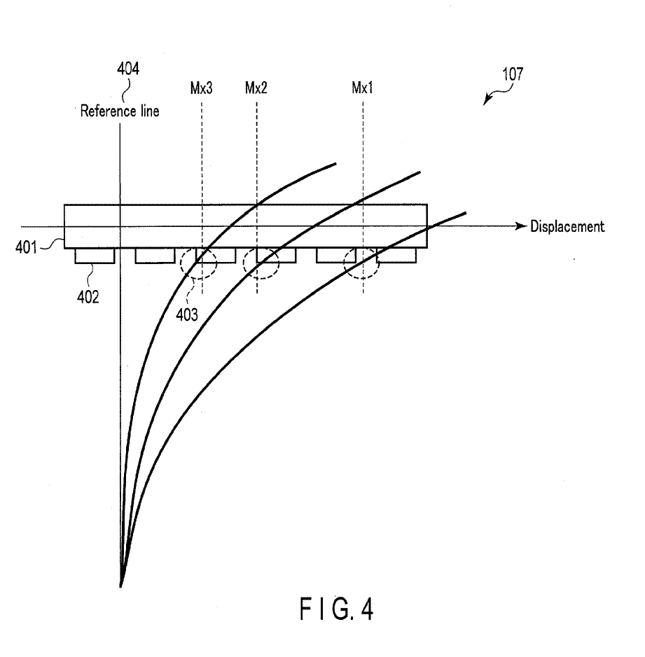

The detector 107 according to the first embodiment will be described in detail below with reference to FIG. 4.

A plurality of gaps 402 are disposed on a substrate 401 as the detection surface of the detector 107 shown in FIG. 4. The gaps 402 have a thickness of nanometer size, and a hot spot 403 is formed between the gaps 402. It is desirable that the height of the hot spot 403 be of nanometer size, or about 1 nm. Since, furthermore, the distance between hot spots has a great influence on an electric field enhancement effect, the distance between the gaps 402 has only to be designed to be of nanometer size, and it is particularly desirable that the distance be set to 10 nm or less.

When the measuring object that has reached the detector 107 is attached to the hot spot 403, the detector 107 emits light toward the hot spot 403, and a photodetector reads light scattered from the hot spot 403. If the emitted light is field-enhanced, its light intensity is enhanced about 10⁶, thereby making it possible to obtain surface-enhanced Raman scattering spectroscopy of the measuring object that has reached the hot spot. The surface-enhanced Raman scattering spectroscopy has a spectrum unique to each measuring object based on the relationship between wavelength and light intensity. Therefore, the measuring object can uniquely be identified by analyzing the unique spectrum.

Incidentally, if a measuring object that has reached the detection surface of the detector 107 is attached at a position closer to a reference line 404, its mass becomes larger, whereas if the measuring object is attached at a more distant position from the reference line in a direction in which the flight trajectory of the measuring object is bent, its mass becomes smaller. The mass and molecular weight can thus be computed at once by the distance measurement method from the displacement and the position of incident light.

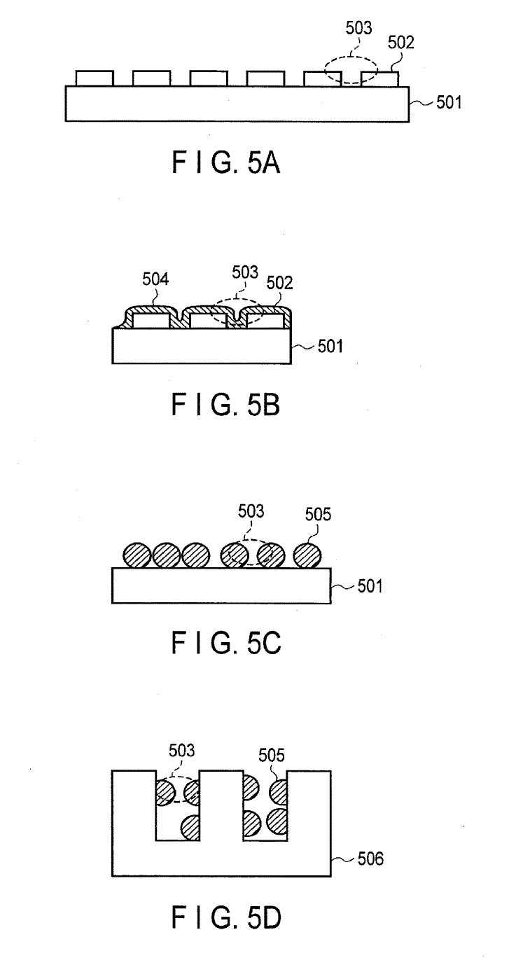

An example of forming hot spots on the detection surface of the detector 107 will be described below with reference to FIGS. 5A to 5D.

FIG. 5A shows a first forming example where a detector 107 including hot spots is generated by forming pattern portions by nano-patterning using a resist.

Specifically, a substrate 501 to be formed by resist materials is sensitized by drawing pattern portions by electron beams to dissolve an unnecessary portion. Then, the resultant structure is etched by plasma with a resist pattern formed thereon. Thus, the pattern portions 502 become nano-gaps, and a hot spot 503 is formed between the nano-gaps. This method allows a plurality of hot spots 503 to be formed at once by a single drawing and is therefore suitable to generate a detector 107 in which a number of hot spots 503 are arranged in parallel.

FIG. 5B shows a second forming example, or another example of patterning. In the example of FIG. 5B, wide hot spots are formed at the time of patterning, and metal is deposited afterward to form hot spots by a nanosized nanostructure layer.

For example, pattern portions 502 having a width of 200 nm are formed on the substrate 501 at intervals of 10 nm, titanium and chromium are deposited as an adhesive layer afterward, and metal and silver are deposited about 5 nm as a nanostructure layer on the adhesive layer, thereby forming an evaporation section 504 In this case, if the deposition is performed by inclining the pattern portions 502, the shape of the hot spot 503 can be varied and the hot spot has a plurality of shapes. It is thus possible to attach the measuring objects with efficiency.

FIG. 5C shows a third forming example where hot spots are formed using nanoparticles.

A nanostructure layer can be formed by applying nanoparticles 505 of chemically synthesized gold and silver to the surface of the substrate. A portion in which the nanoparticles 505 are close to each other acts as a hot spot. It is desirable that the nanoparticles 505 be of about several nanometers.

FIG. 5D shows a fourth forming example where a plurality of nanoparticles 505 are disposed between gaps of a substrate 506 that has been patterned. This arrangement makes it possible to increase the area of hot spots of the detector 107.

The surface of the evaporation section 504 and the surface of the nanoparticles 505 of the metal shown in FIGS. 5A to 5D can be coated with organic molecules. When they are coated with organic molecules, it is desirable to select an appropriate organic molecule according to a measuring object. For example, when the measuring object is an influenza virus, it is desirable to coat the surfaces with α2, 6-sialic acid-containing galactose molecules. When the measuring object is a substance such as ricin and a Shiga toxin, the surfaces have only to be coated with glycoside derivatives.

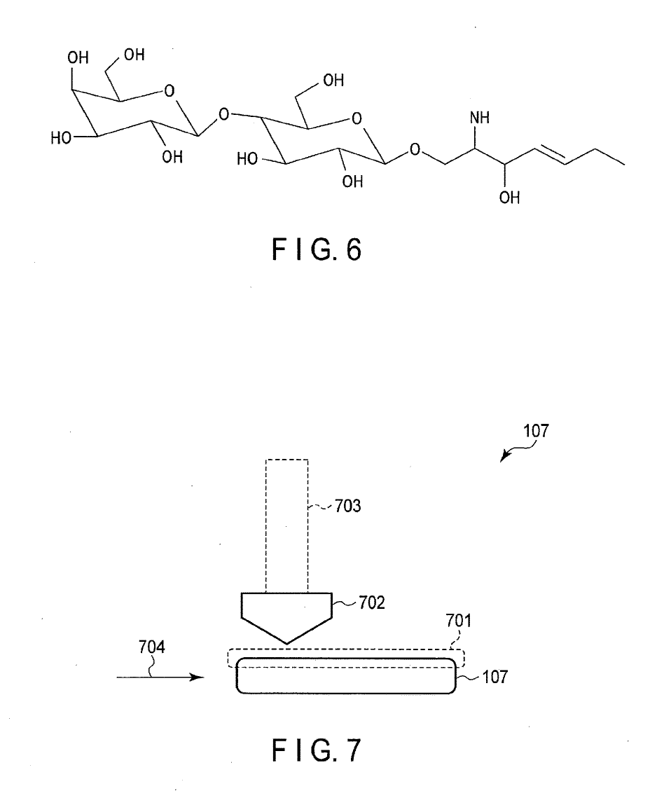

An example of glycoside derivatives is shown in FIG. 6.

It is desirable that a sugar chain structure as shown in FIG. 6 is provided in part of a molecular structure as the glycoside derivatives. When at least one of gold and silver is used as nanoparticles, for example, an amino group, a carbonyl group, a thiol group, a sulfide group, and a disulfide group are provided in the structure of organic molecules with which the nanoparticle surface is coated to be bonded with the nanoparticle metal surface. When the nanoparticles are used, they can be deposited on the substrate and on the surface of a prism to facilitate optical measurement.

A photo-detection process of the detector 107 will be described in detail below with reference to FIG. 7.

In the phot-detection process, laser beams 703 are condensed through an objective lens 702 and emitted to the detection surface 701 to which a measuring object is attached in the detector 107 shown in FIG. 7, and the laser beams are adjusted that their excitation power becomes several milliwatts near the detection surface 701. The laser beams 703 have only to have, for example, a wavelength of about 785 nm and an output of about 100 mW.

The diameter of the laser beams 703 condensed through the objective lens 702 is about 1 μm and is larger about one order of magnitude than that of the measuring objects attached to the hot spots. Thus, even though the measuring objects are randomly attached to the detector 107, Raman scattered light can be generated by irradiating the measuring objects with laser beams. Incidentally, it does not matter if a measuring object the size of which is larger than that of a hot spot is attached. This is because even though the measuring objects are attached to a plurality of hot spots, an electric field can be enhanced to generate Raman scattered light.

The light scattered by surface-enhanced Raman scattering by the laser beams 703 is incident upon the objective lens 702 and is dispersed and detected. In the photo-detection, Raman scattering spectroscopy can be observed to obtain a spectrum representing a relationship between a wavelength (Kaiser: cm⁻¹) and intensity. Since the observation of Raman scattered light in the detector 107 has only to be performed by a general Raman measurement process, its detailed descriptions will be omitted.

In addition, a photo-detection process can be performed for a measuring object, which is attached to the detection surface 701 by moving the objective lens 702, but it is desirable to move and rotate the detector 107 in order to avoid deviating from the optical path of the laser beams 703. For example, the direction can be changed by inclining the detection surface 701 by 90 degrees from the direction in which the measuring object has been flying (flight trajectory 704 in FIG. 7). Thus, the object is easily caused to get close to the objective lens 702, and the objective lens 702 can be placed without overlapping the flight trajectory of the object, thereby suppressing a deviation of the optical path. When a measuring object is difficult to observe even by the surface-enhanced Raman scattering, it is desirable to trap the measuring object, and the ion trap is effective. The ion trap has a DC type and an AC type, and ions can be supplemented according to the Mathieu equation. Therefore, the measuring object can be supplemented sufficiently using the ion trap. According to the first embodiment described above, ions are attached to substances that are a measuring object, such as viruses floating in the air. After that, a voltage is applied to the ionized substances to cause the substances to fly in measurement space, and an additional voltage is applied to the ionized substances to bend the flight trajectory of the substances and then remove unnecessary ionized substances. Thus, only the ionized substances having a desired mass can be caused to reach the detector nondestructively as a measuring object. A photo-detection process is performed for the measuring object, which has reached the detector, by the surface enhanced Raman scattering or the like to identify the object that is detected nondestructively, in a short time and easily.

If, moreover, the flight trajectory of the ionized substances is bent, the length of a flight tube of the measurement space can be shortened, thereby miniaturizing the molecular detection apparatus.

### Second Embodiment

It is likely that another substance that has entered the molecular detection apparatus will be detected erroneously as an object to be measured. To prevent such erroneous detection, it is desirable to provide a multiple detection mechanism and it is possible to acquire and evaluate data by not a single detector but a plurality of detection systems. However, providing a plurality of detectors at different locations for detection will increase the volume of the apparatus system and cause the disadvantages that measurement of a very small number of objects to be detected is inefficient.

Therefore, in the second embodiment, one detector performs both a photo-detection process and an electron detection process to prevent erroneous detection and detect an object with efficiency.

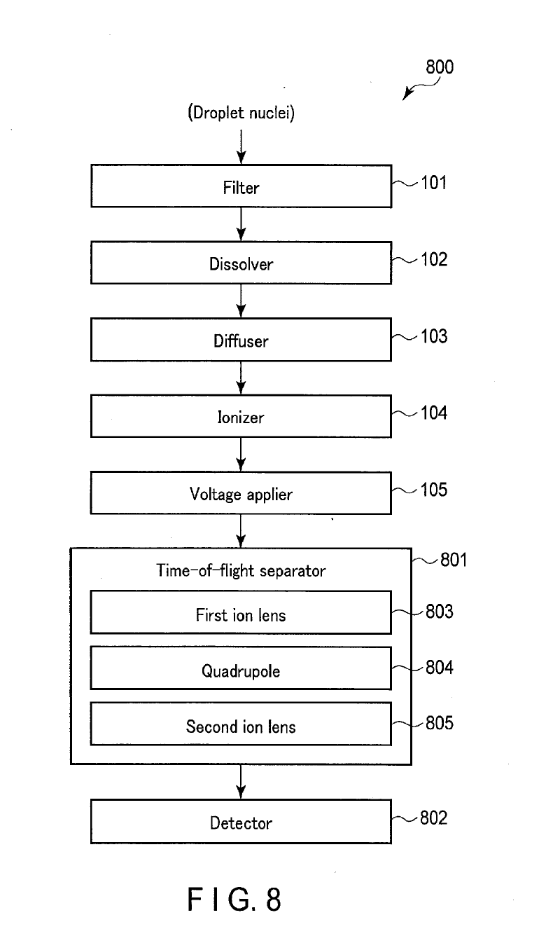

The molecular detection apparatus according to the second embodiment will be described with reference to FIG. 8.

A molecular detection apparatus 800 according to the second embodiment includes a filter 101, a dissolver 102, a diffuser 103, an ionizer 104, a voltage applier 105, a time-of-flight separator 801 and a detector 802.

The filter 101, dissolver 102, diffuser 103, ionizer 104 and voltage applier 105 perform the same operations as those in the first embodiment and thus the operations will be omitted here.

The time-of-flight separator 801 includes a first ion lens 803, a quadrupole 804 and a second ion lens 805.

The first ion lens 803 adjusts the diameter of an ionized substance group flying in the flight tube for the quadrupole 804 at the subsequent stage.

The quadrupole 804 ejects a substance included in the ionized substance group the diameter of which is adjusted by the first ion lens 803, which does not meet any voltage conditions, out of a pole and extracts an ionized substance having a desired molecular weight as a measuring object.

The second ion lens 805 further narrows the diameter of the ionized substance having a desired molecular weight to gather the ionized substance in the center thereof.

The detector 802 performs both a photo-detection process for detecting Raman scattered light by the surface enhanced Raman scattering for an object that has reached, and an electron detection process for electronically detecting an object that has reached by a graphene layer.

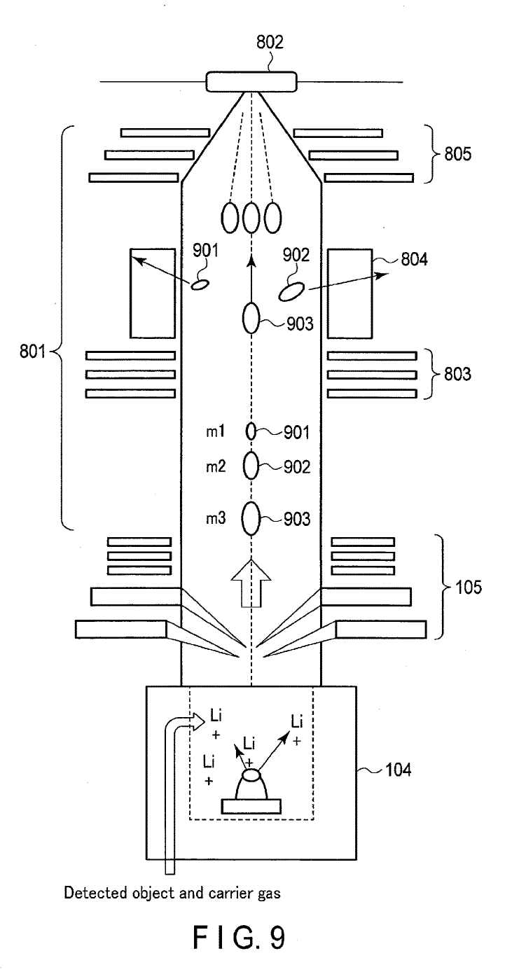

A specific example of the ionizer 104, the voltage applier 105 and the time-of-flight separator 801 will be described below with reference to the conceptual diagram of FIG. 9.

FIG. 9 shows a relationship in arrangement among the ionizer 104, the voltage applier 105 and the time-of-flight separator 801. The processes of the ionizer 104 and the voltage applier 105 are the same as those in the first embodiment.

Assume in FIG. 9 that the voltage applier 105 applies a voltage and ionized substances 901, 902 and 903 fly in a flight tube. Also, assume that the mass of the ionized substance 901 is m1, that of the ionized substance 902 is m2, that of the ionized substance 903 is m3, and the relationship in mass is m3>m2>m1.

The first ion lens 803 narrows the diameter of the flight trajectory of the ionized substances 901, 902 and 903 to such an extent that they can be guided to the quadrupole 804 in the subsequent stage.

It is desirable that the route to the quadrupole 804 be a route bent from a reference line using a chicane lens. The bent route makes it possible to efficiently remove neutral substances and photons generated during the ionization process in the ionizer 104. The quadrupole 804 ejects substances other than a substance that meets arbitrary voltage conditions out of a pole according to the general Mathieu equation and extracts only the ionized substance (a measuring object) having a desired molecular weight.

In FIG. 9, for example, when only the ionized substance 903 is a measuring object, the voltage conditions have only to be set in such a manner that the ionized substances 901 and 902 whose masses are m1 and m2, respectively are ejected out of the quadrupole 804, and the ionized substance 903 whose mass is m3 is left in the quadrupole 804.

The second ion lens 805 is, for example, an Einzel lens to converge the width of the flight trajectory of the ionized substance 903 outside the lens and lead the ionized substance to the detector 802.

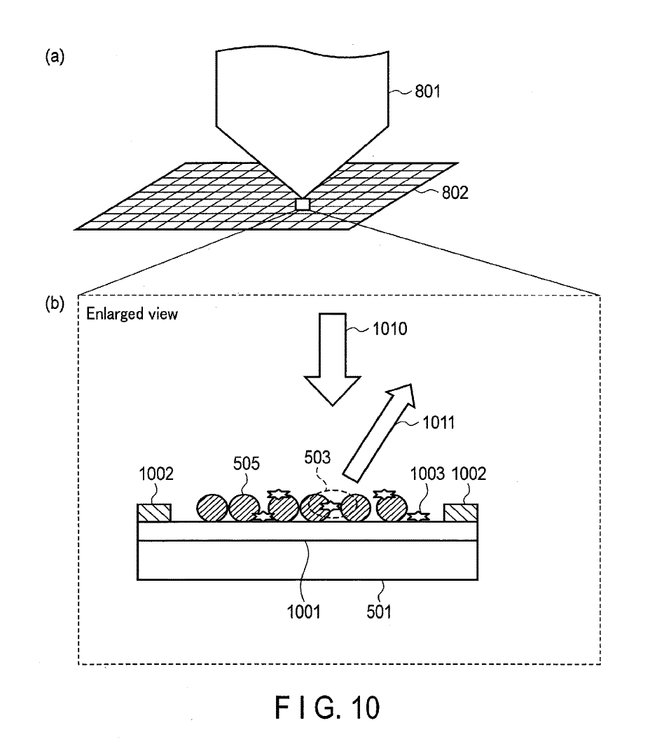

The photo-detection process and electron detection process of the detector 802 according to the second embodiment will be described below with reference to FIG. 10.

FIG. 10(a) shows an example of the arrangement of the time-of-flight separator 801 and the detecting unit 802, and a measuring object is released from the tip of the time-of-flight separator 801. If the distance between the tip of the time-of-flight separator 801 and the detector 802 is long, ions are spread to decrease detection efficiency and thus it is desirable to set the distance at about 1 cm or shorter.

Furthermore, as shown in FIG. 10(b), the detector 802 is formed by laminating a graphene layer 1001 on the substrate and depositing nanoparticles 505 on the graphene layer 1001 as a nanostructure layer. Furthermore, an electrode 1002 is connected to each of the end portions of the graphene layers 1001. The graphene layer 1001 has only to be formed using chemical vapor deposition (CVD). It is desirable to form the layer on a substrate of silicon, silicon oxide, aluminum oxide, magnesium oxide, silicon carbide or the like. As the nanoparticles 505, nanoparticles formed by at least one of gold and silver have only to be used.

A vapor deposition graphene can be formed by CVD after a metal evaporation layer such as nickel, copper and cobalt is formed on the substrate. A metal layer that is no longer required has only to be removed by etchant. Here, as the photo-detection process, a laser beam 1010 is incident upon an object 1003 to be detected, which is attached to the nanoparticles 505 deposited on the graphene layer 1001, to thereby observe surface enhanced Raman scattering light 1011. From the surface enhanced Raman scattering light 1011, a spectrum of surface-enhanced Raman scattering spectroscopy has only to be obtained.

Moreover, as the electron detection process, when a measuring object has reached, an electronic signal is detected from the electrode 1002 connected to the graphene layer 1001. This electron detection process makes it possible to detect whether a measuring object has reached.

In addition, it is desirable to form the detector in an array, and elements to form the array are arranged to become wells of about several micrometers. If, therefore, an electrical signal and an optical signal are acquired from each of the wells, erroneous detection can be prevented with efficiency.

According to the second embodiment described above, unnecessary ionized substances are ejected using the ion lens and the quadrupole to lead only a desired ionized substance to the detector as a measuring object, to obtain an electrical signal using a graphene layer in the detector when the measuring object has reached, and also observe Raman scattered light. This makes it possible to identify the measuring object by both the photo-detection process and the electron detection process and to suppress erroneous detection of the measuring object with efficiency.

The time-of-flight separator 106 according to the first embodiment and the detector 802 according to the second embodiment can be combined. Even though the flight trajectory of a measuring object is bent by the time-of-flight separator 106 to lead the object to the detector 802, the detector 802 is able to identify the object by performing both the photo-detection process and the electro detection process, thereby suppressing erroneous detection of a measuring object with efficiency.

### Third Embodiment

The third embodiment differs from the foregoing embodiments in that the spectrum of an object detected by the detector and the spectrum stored in a database are collated with each other to identify a substance of the measuring object.

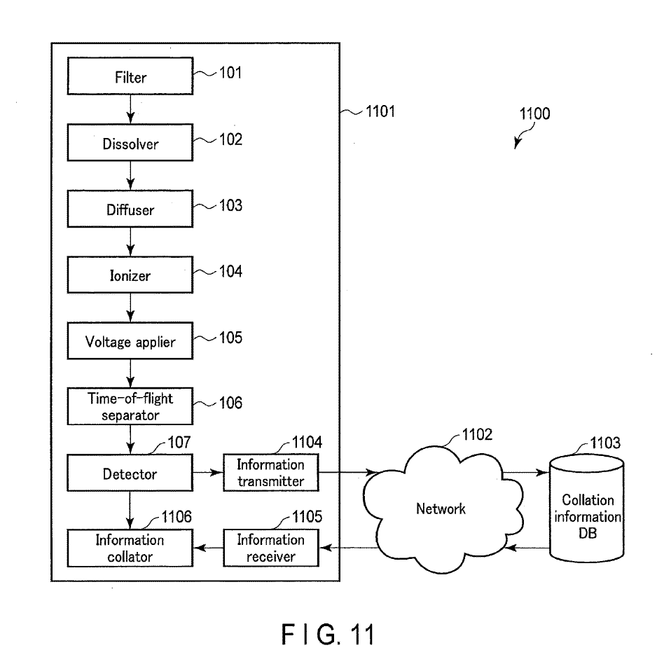

A molecular detection system including a molecular detection apparatus according to the third embodiment will be described with reference to the block diagram of FIG. 11.

The molecular detection system 1100 includes a molecular detection apparatus 1101, a network 1102 and a collation information database (DB) 1103.

The molecular detection apparatus 1101 includes an information transmitter 1104, an information receiver 1105 and an information collator 1106 in addition to the configuration of the molecular detection apparatus 100 according to the first embodiment.

The information transmitter 1104 transmits a request signal for requesting spectral data on a substance to be assumed as a measuring object to the collation information database DB 1103 through the network 1102.

The collation information database 1103 receives a request signal from the information transmitter 1104 and, in response to the request signal, transmits a spectrum of the surface-enhanced Raman scattering spectroscopy for one or more substances which are assumed to be a measuring object (hereinafter also referred to as SERS spectrum or reference spectrum) to the molecular detection apparatus 1101 through the network 1102. Here, data of an SERS spectrum of pathogens the infection of which is likely to spread at the time of measurement is assumed.

The Information receiver 1105 receives data of an SERS spectrum for one or more pathogens from the collation information database 1103.

The information collator 1106 receives data of the spectrum of a measuring object detected from the detector 107 and data of the SERS spectrum of one or more pathogens from the information receiver 1105, and collates the detected data and the SERS spectrum data. If the SERS spectrum data of the detected data and the received SERS spectrum data coincide with each other, it is possible to identify what substance the measuring object is.

The spectrum data of the object detected by the detector 107 can be transmitted to a server including the collation information database 1103, the server may perform a spectrum collation process, and the information receiver 1105 may receive data of collation results from the server. It is thus possible to reduce a load in the molecular detection apparatus.

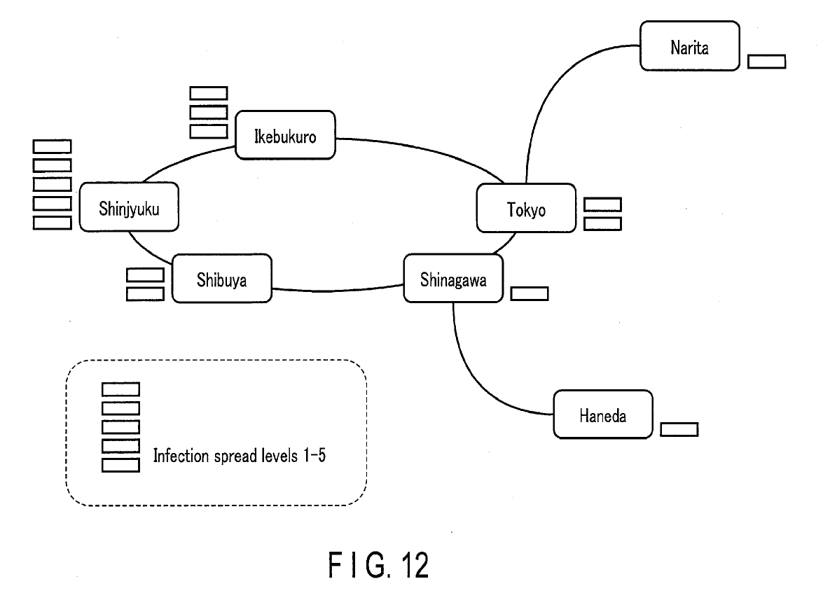

An example of use of data on an identified measuring object will be described below with reference to FIG. 12.

FIG. 12 shows an example of creating an infection spread map based on the pathogen of the identified object. The infection spread map represents which location the pathogen has been observed at and how much it has been done as an infection spread level. “Narita”, “Tokyo”, “Haneda”, “Shinagawa”, “Shibuya”, “Shinjyuku” and “Ikebukuro” are station names in Japan.

The infection spread map has only to be created by, for example, transmitting data including information about a pathogen identified by the molecular detection apparatus 1101 at several locations, time information that identifies the pathogen and information of a position in which the molecular detection apparatus 1101 is installed, to a server including collation information data and mapping the information of a corresponding pathogen based on the position information by the server. Since, moreover, the molecular detection apparatus 1101 transmits the data to the server by associating time at which a measuring object is identified, with the data, the situation of infection spread can be grasped along in time sequence.

In the example of FIG. 12, while the infection spread level is “Level 5” in Shinjuku, it is “Level 1” in Shinagawa. Since, therefore, it is easily understandable that the infection spreads in Shinjuku, for example, the administration and medical institutions are able to take prevention measures against the infection spread efficiently and rapidly. If, moreover, the molecular detection apparatus 1101 is installed in places where a number of people gather, such as doors and platforms for public transportation, underground shopping centers, interiors of buildings, schools and libraries to obtain detection data on pathogens in a broad range, a spread of infection conditions can accurately be grasped and a preventive effect on infection can be enhanced.

According to the third embodiment described above, an SERS spectrum such as a pathogen is received from the database and the received SERS spectrum is compared with the spectrum of an object measured by the detector to make it possible to identify the object. It is also possible to easily understand where and how the pathogen spreads in association with, e.g. the location and time of the identified object.

Examples of use of the molecular detection apparatuses according to the foregoing embodiments will be described below. The following first and second examples are cases of using the molecular detection apparatus according to the first embodiment, and the following third example is a case of using the molecular detection apparatus according to the second embodiment.

### First Example

As a first example, a case of using a glycohemoglobin as a measuring object will be described. The glycohemoglobin is a substance used for examination as a diabetes factor and exists as one of a variety of substances in blood. Specifically, a sample is prepared by mixing the glycohemoglobin, which is separated from blood, with urea and then used as a measuring object.

As a solvent for dissolving a measuring object, ultrapure water excluding excess particles through a filter, such as purified water of a type called milli-Q water, is used. The ultrapure water is used to eliminate an excess mixture, or a contaminant. After a measuring object is dissolved, it is sprayed like a slide glass to deposit liquid droplets thereon. The slide glass is dried or about two hours in an oven set at 20° C. The dried sample is peeled off the slide glass and re-dispersed in a solution of a second example listed in Table 1.

TABLE 1

| | | Solution | | |
|---|---|---|---|---|
| | | Solvent 2 | | |
| | Solution | (Mixed | Separation | Processing |
| | Solvent 1 | Solvent) | Method | Temperature |
| First | Ultrapure | None | Precipitate | 23° C. |
| Example | Water | | | |
| Second | Ultrapure | None | Centrifugation | 23° C. |
| Example | Water | | | |
| Third | Ultrapure | None | Centrifugation | 30° C. |
| Example | Water | | | |
| Fourth | Ultrapure | Sucrose | Centrifugation | 23° C. |
| Example | Water | | | |
| Fifth | Ultrapure | Methanol | Centrifugation | 20° C. |
| Example | Water | | | |

After that, the solution is separated by centrifugation to form a precipitate. It is desirable to perform the centrifugation at about several thousand rpm that is equivalent to an ultracentrifuge. The precipitate is separated relatively slowly by selecting 3000 rpm. If a relatively high centrifugal separation is performed, proteins precipitated below are easy to fix densely. It is thus necessary to prevent the proteins from being fixed. Samples of chiefly the separated precipitate are removed to generate droplets by an ultrasonic nebulizer together with the solution. Some samples may generate nano-order droplets by electrospray by capillaries and, in this case, a droplet of 1 micrometer or less is formed.

The dispersed droplets are guided to the ionizer and ionized by lithium ions emitted from the heated lithium ion source. After that, a measuring object is allowed to fly in the flight tube in a high vacuum due to the action of a voltage. For example, an acceleration voltage in the second example shown in Table 2 is applied.

TABLE 2

| | Voltage 1 | Voltage 2 | | |
|---|---|---|---|---|
| | Acceleration | First | Second | Third |
| | Voltage | Segment | Segment | Segment |
| First | 1000 V | 0 V | 0 V | 5 V |
| Example | | | | |
| Second | 1500 V | 300 V | 20 V | 5 V |
| Example | | | | |
| Third | 2000 V | 400 V | 28 V | 5 V |
| Example | | | | |

The time-of-flight separator 106 applies a voltage, which corresponds to voltage 2 of the second example shown in Table 2, to the ionized substance group that is flying. A first segment voltage of 300 V, a second segment voltage of 20 V and a third segment voltage of 5V are applied. Thus, the flight trajectory of the flying ionized substance group is bent and the flying ionized substance group is attached to the detector 107 having a hot spot that is silver deposited.

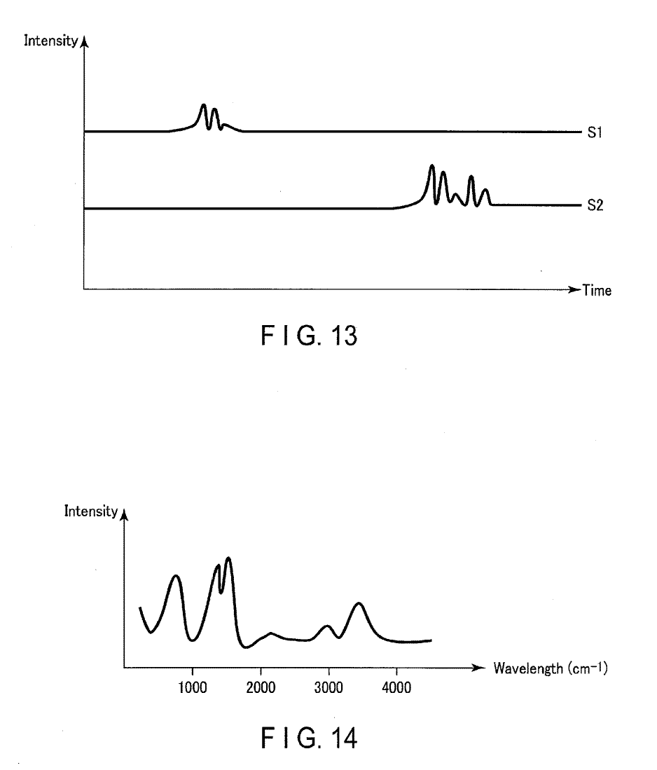

The results obtained by detecting signals by an electron multiplying method when a measuring object is attached to the detector 107 is shown in FIG. 13.

In the graph shown in FIG. 13, the vertical axis represents intensity and the horizontal axis represents time. The peaks represented by S1 and S2 in FIG. 13 make it possible to electronically confirm that the measuring object flies and is attached to the detector 107.

FIG. 14 shows the SERS spectrum of the measuring object according to the first example by the photo-detection process after it is confirmed that the object is attached as shown in FIG. 13 by the electron multiplying method. In the graph shown in FIG. 14, the vertical axis represents signal intensity and the horizontal axis represents wavelength (cm⁻¹). As shown in FIG. 14, the SERS spectrum of glycohemoglobin HbAlc can be obtained in the vicinity of the wavelength of 1000 to 4000 cm⁻¹.

When glycohemoglobin and urea are objects to be detected as a comparative example, the same process as in the first example is carried out to guide the objects to the ionizer 104 and then use the first example in Table 2 to cause the objects to fly in the flight tube and measure them using the silver-deposited hot spot. The spectrum due to the Raman scattered light to be acquired saturates the intensity, and a characteristic spectrum cannot be read.

### Second Example

As a second example, a case where a sample produced by mixing a solution of an influenza inactivated vaccine H1N1 and mucin (gastric type) dispersed in water is used as a measuring object, will be described.

The sample is sprayed like a slide glass to deposit liquid droplets thereon and then dried for about two hours in an oven set at 20° C. The dried sample is removed from the slide glass and re-dispersed in the solution. After that, the third example in Table 1 is utilized to form a precipitate by centrifugation. A supernatant portion to be formed is removed to generate liquid droplets by an ultrasonic nebulizer device together with the solution. The liquid droplets are guided to the ionizer 104 and ionized by lithium ions. Then, they are caused to fly in the flight tube using a voltage of the third example in Table 2. The surface enhanced Raman scattered light of the measuring object attached to the detector 107 in which a gold-deposited hot spot is formed, is obtained.

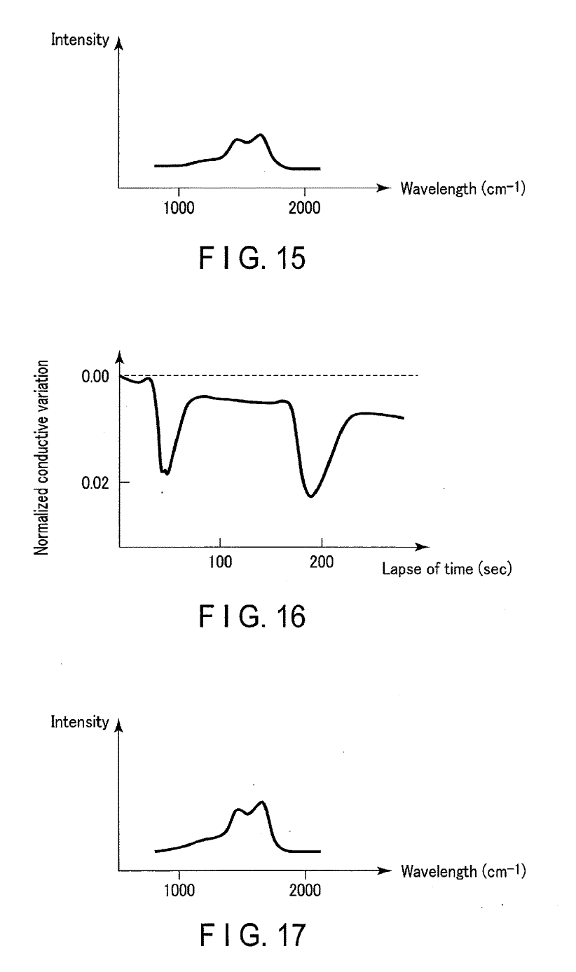

FIG. 15 shows the SERS spectrum of the measuring object according to the second example. As shown in FIG. 15, the SERS spectrum of influenza H1N1 can be obtained in the vicinity of the wavelength of 1000 to 2000 cm⁻¹.

As a comparative example, using the fourth example in Table 1, a sample produced by mixing a solution of an influenza inactivated vaccine H1N1 and mucin (gastric type) dispersed in water is used as a measuring object. Thus, the sample is re-dissolved in a solution of ultrapure water and sucrose and centrifuged at 10000 rpm. If the fourth example is used, a fixed object is generated in a centrifuge tube; thus, it is unsuitable for forming liquid droplets by an ultrasonic nebulizer or emitting from the nozzle of an electrospray by capillaries.

As another comparative example, using the fifth example in Table 1, a sample produced by mixing a solution of an influenza inactivated vaccine H1N1 and mucin (gastric type) dispersed in water is used as a measuring object. Thus, the sample is re-dissolved in a solution of ultrapure water and methanol and centrifuged, thereby generating a whitish precipitant of a mucin mixed liquid. Therefore, it is unsuitable for forming liquid droplets by an ultrasonic nebulizer.

### Third Example

When, as a third example, a sample produced by mixing a solution of an influenza inactivated vaccine H1N1 and mucin (gastric type) dispersed in water is used as a measuring object, ultrapure water is used as a solvent, the centrifugation is used as a separation method, and an acceleration voltage is set at 2000 V. After that, the time-of-flight separator 801 according to the second embodiment performs a process to guide the measuring object to the detector 802.

Here, the detector employs a sapphire substrate made of aluminum oxide. Cobalt is deposited about 200 nm by sputtering on the C-axis orientation surface of the sapphire substrate. The cobalt phase is subjected to hydrogen annealing at 500° C., and a graphene layer is subjected to chemical vapor deposition (CVD) at 1000° C. using methane as raw material gas. Polymethylmethacrylate (PMMA) whose molecular weight is 50,000 to 200,000 is applied to remove the cobalt layer at 3% by volume of hydrochloric acid. The graphene layer is transferred onto a silicon substrate with the PMMA, and the remaining PMMA is removed with alkali such as sodium hydroxide.

On the other hand, silver nanoparticles are produced by a method of reducing silver nitrate and amine by sodium borohydride. The produced silver nanoparticles are dispersed in toluene that is an organic solvent and have a distribution of about 1 to 10 nm. This is applied to the graphene layer at about 2000 to 3000 rpm by the spin coat method. Water dispersion type silver nanoparticles can be applied to the graphene layer in the same manner. After the application, it is placed on a hot plate and the solvent is thoroughly removed. A vapor deposition electrode such as aluminum and gold is formed at the end of the graphene layer. At this time, wire bonding can be formed. In this way, an array-shaped detector is formed.

Then, the time-of-flight separator 801 is disposed such that its termination is close to the detector 802. The measuring object, which is extracted by the flight separation, is discharged through the second ion lens 805 and attached to the detector 802.

When signals of flying substances are detected, two signals are separated by the electron detection process. The signal generated by graphene is shown in FIG. 16 as an electron detection process for a measuring object, which is influenza H1N1.

In FIG. 16, the vertical axis represents a normalized conductive variation and the horizontal axis represents a time axis.

A measuring object is attached two times and the normalized conductive variation of graphene occurs two times (peaks 1601 and 1602). Thus, an electron detection process of the measuring object can be performed by detecting the conductive variation.

FIG. 17 shows a detection result of SERS spectrum obtained together with the conductive variation in FIG. 16 as the photo-detection process of influenza H1N1.

As shown in FIG. 17, the SERS spectrum can be obtained in the vicinity of 1000 to 2000 cm⁻¹ wavelength.

In the present embodiments, a virus floating in the air is defined as a measuring object and can be analyzed by extracting a component from blood or the like. According to the molecular detection apparatuses according to the present embodiments, even though the number of viruses in blood components is very small, they can be analyzed; thus, the presence or absence of infection can be determined before the viruses grow.

Conventionally, in order to grow viruses from blood collected from a patient, it is necessary to operate in a room at a biosafety level room using separately prepared cultured cells and embryonated chicken eggs, while avoiding contamination of other viruses. Furthermore, in a technique such as real-time PCR, though analysis time is relatively short, a virus needs to be separated and extracted as a preliminary operation, and many operations are required through the entire process. On the other hand, if the molecular detection apparatuses according to the present embodiments are used, a virus can be separated and detected by a simpler operation without any virus growth process and a patient is able to know that he or she has infected with a virus before his or her pathogenesis.

If the above example is applied, a source of disease, such as a small number of viruses and bacteria contained in blood collected for transfusion is detected and identified for each specimen to reduce operation costs and operation time significantly and eliminate a test blank period (a so-called window period) before a positive test result is obtained. This makes it possible to provide safer, more secure medical care.

A measuring object is not limited to viruses or bacteria, but other substances can be used as a measuring object.

While certain embodiments have been described, these embodiments have been presented by way of example only, and are not intended to limit the scope of the inventions. Indeed, the novel apparatuses, methods and computer readable media described herein may be embodied in a variety of other forms; furthermore, various omissions, substitutions and changes in the form of the apparatuses, methods and computer readable media described herein may be made without departing from the spirit of the inventions. The accompanying claims and their equivalents are intended to cover such forms or modifications as would fall within the scope and spirit of the inventions.

What is claimed is:

1. A molecular detection apparatus comprising:
an ionizer that attaches ions to a substance group including substances that differ in molecular weight to obtain an ionized substance group;
a voltage applier that applies a first voltage to the ionized substance group to cause the ionized substance group to fly toward a detection surface within measurement space;
a separator that applies a second voltage to a flying ionized substance group to bend a flight trajectory of the flying ionized substance group, removes a substance whose molecular weight is not more than a threshold value from the flying ionized substance group, and extracts a substance whose molecular weight is more than the threshold value as a measuring object; and
a detector that performs a photo detection process to obtain a spectrum of the measuring object attached to the detection surface.

2. The apparatus according to claim 1, wherein the detector performs the photo detection process and an electron detection process to detect an electrical signal generated when the measuring object is attached to the detection surface.

3. The apparatus according to claim 2, wherein the photo detection process is a process to detect scattered light of the measuring object attached to a nanostructure, and the electron detection process is a process to detect the electrical signal by graphene.

4. The apparatus according to claim 2, wherein the detector is formed by forming a graphene layer on a substrate made of one of silicon, silicon oxide, aluminum oxide, magnesium oxide and silicon carbide, forming a nanostructure layer on the graphene layer, and forming an electrode on part of the graphene layer.

5. The apparatus according to claim 4, wherein the nanostructure layer includes at least one of gold and silver.

6. The apparatus according to claim 1, further comprising:
a dissolver that dissolves droplet nuclei including the measuring object in a solution; and
a diffuser that diffuses the measuring object included in the solution.

7. The apparatus according to claim 1, wherein the photo detection process is a process to detect Raman scattering spectroscopy or surface-enhanced Raman scattering spectroscopy.

8. The apparatus according to claim 1, wherein the ions are lithium ions or sodium ions.

9. The apparatus according to claim 1, wherein the measuring object is viruses or bacteria.

10. The apparatus according to claim 1, further comprising:
a receiver that receives a reference spectrum obtained by performing a photo detection process on a substance to be assumed as the measuring object; and
a collator that collates the reference spectrum with a spectrum of the measuring object.

11. The apparatus according to claim 1, wherein the threshold value is 3000.

12. A molecular detection apparatus comprising:
an ionizer that attaches ions to a substance group including substances that differ in molecular weight to obtain an ionized substance group;
a voltage applier that applies a first voltage to the ionized substance group to cause the ionized substance group to fly toward a detection surface within measurement space;
a quadrupole that applies a second voltage to a flying ionized substance group, ejects a substance whose molecular weight is not more than a threshold value from the flying ionized substance group, and extracts a substance whose molecular weight is more than the threshold value as a measuring object;
a lens that condenses a diameter of an ion the measuring object; and
a detector that performs an electron detection process to detect an electrical signal generated when the measuring object is attached to the detection surface and a photo detection process to obtain a spectrum of the measuring object attached to the detection surface.

13. A molecular detection method comprising:
attaching ions to a substance group including substances that differ in molecular weight to obtain an ionized substance group;
applying a first voltage to the ionized substance group to cause the ionized substance group to fly toward a detection surface within measurement space;
applying a second voltage to a flying ionized substance group to bend a flight trajectory of the flying ionized substance group;
removing a substance whose molecular weight is not more than a threshold value from the flying ionized substance group;
extracting a substance whose molecular weight is more than the threshold value as a measuring object; and performing a photo detection process to obtain a spectrum of the measuring object attached to the detection surface.

14. A molecular detection method comprising:
attaching ions to a substance group including substances that differ in molecular weight to obtain an ionized substance group;
applying a first voltage to the ionized substance group to cause the ionized substance group to fly toward a detection surface within measurement space;
applying a second voltage to a flying ionized substance group;
ejecting a substance whose molecular weight is not more than a threshold value from the flying ionized substance group;
extracting a substance whose molecular weight is more than the threshold value as a measuring object;
condensing a diameter of an ion the measuring object; and
performing an electron detection process to detect an electrical signal generated when the measuring object is attached to the detection surface and a photo detection process to obtain a spectrum of the measuring object attached to the detection surface.
